(19) United States
(12) Patent Application Publication
(10) Pub. No.: US 2024/0259120 A1
(43) Pub. Date: Aug. 1, 2024

(54) Method and Network Node for Interference Mitigation in a TDD Wireless Communication Network

(71) Applicant: Telefonaktiebolaget LM Ericsson (publ), Stockholm (SE)

(72) Inventors: Junaid Ansari, Aachen (DE); Vijaya Parampalli Yajnanarayana, Bangalore (IN); Alexandros Palaios, Herzogenrath (DE)

(21) Appl. No.: 18/565,709

(22) PCT Filed: Jun. 1, 2021
(86) PCT No.: PCT/EP2021/064619

§ 371 Date: Nov. 30, 2023

(51) Int. Cl. H04B 17/345; H04B 17/29

(52) U.S. Cl. CPC H04B 17/345; H04B 17/29

(57) ABSTRACT

Network equipment (20) is configured for use in a wireless communication network (10). The network equipment (20) determines an inter-network interference condition (50C) measured by a set of sensors (30) deployed in a coverage area of the wireless communication network (10). The inter-network interference condition (50C) characterizes interference to the wireless communication network (10) from one or more other wireless communication networks (50). Based on the determined inter-network interference condition (50C), the network equipment (20) adapts time division duplexing, TDD, configuration (14) of one or more radio network nodes (12) in the wireless communication network (10).

### TECHNICAL FIELD

The present application relates generally to a wireless communication network, and relates more particularly to interference mitigation in such a network.

### BACKGROUND

In Time-Division-Duplexing (TDD) operation of a wireless communication network, the same frequency band is used for uplink and downlink transmissions. A radio frame is divided into uplink and downlink subframes and they are time-multiplexed within the radio frame.

In a semi-static TDD network, such as a Long Term Evolution (LTE) network, radio network equipment can be flexibly configured with any TDD pattern included in a predefined subset of TDD patterns. The TDD patterns in the predefined subset offer different ratios of uplink and downlink subframes, for handling variations in uplink traffic demand versus downlink traffic demand. Still, the TDD patterns in the preconfigured subset provide some level of harmonization and synchronization among different radio network equipment using potentially different TDD patterns, e.g., all TDD patterns in the subset start with a downlink subframe, followed by a special subframe and then an uplink subframe.

By contrast, in a dynamic TDD (D-TDD) network, such as a New Radio (NR) network, the TDD patterns usable are not limited to a predefined subset of TDD patterns. Instead, radio network equipment has full flexibility to use any possible TDD pattern, so that the TDD pattern can be dynamically tailored to instantaneous traffic demands and/or application behavior. Dynamic TDD therefore improves spectrum utilization efficiency and reduces latency.

However, in D-TDD, the TDD patterns independently selected for use by different radio network equipment may not be harmonized or synchronized to any extent. The cost of increased flexibility to handle varying traffic conditions is therefore an increase in interference.

The increase in interference attributable to D-TDD includes not only intra-network interference, but also inter-network interference between different D-TDD networks. This inter-network interference, also referred to as cross-link interference, can be mitigated to some extent by the networks coordinating TDD pattern selection. In practice, though, this coordination proves insufficient for perfectly aligning TDD patterns across networks. Moreover, the coordination imposes an artificial limitation on which TDD pattern can be used at any given time so as to frustrate the full flexibility otherwise offered by D-TDD.

Challenges exist therefore in exploiting D-TDD for full TDD pattern flexibility while at the same time minimizing inter-network interference. Unmitigated inter-network interference threatens to increase latency (due to re-transmissions) and degrade throughput (due to poor signal quality), whereas non-optimal TDD patterns increase latency by increasing the total waiting period for downlink or uplink slots to occur. These challenges prove particularly problematic in mission-critical applications and industrial internet-of-things (IoT) where quality of service (QoS) requirements are stringent, e.g., low, bounded latency and very high reliability.

### SUMMARY

Embodiments herein exploit a set of sensors deployed in a wireless communication network's coverage area for measuring inter-network interference from other wireless communication network(s). Based on the measured inter-network interference, embodiments herein adapt time division duplexing (TDD) configuration of radio network node(s) in the wireless communication network. Adapting TDD configuration to account for measured inter-network interference in this way may advantageously enable the network to retain flexibility and autonomy over its TDD configuration while also mitigating the impact of the inter-network interference on latency and throughput. Some embodiments may thereby be particularly applicable for exploiting dynamic TDD with low latency in mission-critical applications or industrial internet-of-things (IoT).

More particularly, embodiments herein include a method performed by network equipment configured for use in a wireless communication network. The method comprises determining an inter-network interference condition measured by a set of sensors deployed in a coverage area of the wireless communication network. In this case, the inter-network interference condition characterizes interference to the wireless communication network from one or more other wireless communication networks. The method also comprises adapting, based on the determined inter-network interference condition, time division duplexing, TDD, configuration of one or more radio network nodes in the wireless communication network.

In some embodiments, the method further comprises obtaining a model that models, for each of multiple candidate TDD configurations of the one or more radio network nodes, performance achievable with the candidate TDD configuration under different inter-network interference conditions. In this case, adapting comprises selecting, from the candidate TDD configurations, a candidate TDD configuration that, according to the model, achieves a performance objective under an inter-network interference condition corresponding to the determined inter-network interference condition, and configuring the one or more radio network nodes with the selected candidate TDD configuration.

In one or more of these embodiments, obtaining the model comprises obtaining a labeled dataset that comprises one or more measurement records for each of the candidate TDD configurations. In this case, each measurement record comprises a measurement of performance achieved with the candidate TDD configuration and a measurement by the set of sensors of an inter-network interference condition under which the performance was measured. In one or more of these embodiments, each measurement record also comprises a measurement of a channel condition at one or more wireless devices under which the performance was measured. Alternatively or additionally, in one or more of these embodiments, selecting a candidate TDD configuration comprises selecting, from among one or more measurement records that include a measurement of an inter-network interference condition that is similar to the determined inter-network interference condition according to similarity criteria, a measurement record that includes a measurement of performance meeting a performance objective. Selecting a candidate TDD configuration in this case may comprise selecting the candidate TDD configuration for which the selected measurement record was obtained.

In some embodiments, selecting a candidate TDD configuration comprises selecting, from the candidate TDD configurations, a candidate TDD configuration that, according to the model, achieves a performance objective while meeting one or more performance constraints, under an inter-network interference condition corresponding to the determined inter-network interference condition. In one or more of these embodiments, the performance objective comprises a maximum sum-throughput of the wireless communication network, and the one or more performance constraints include a bounded latency and a minimum throughput for each wireless communication device in the wireless communication network.

In one or more embodiments, adapting TDD configuration of the one or more radio network nodes comprises adapting, based on the determined inter-network interference condition, TDD configuration of multiple radio network nodes in the wireless communication network. In this case, each candidate TDD configuration is a candidate combination of multiple TDD patterns with which to respectively configure the multiple radio network nodes.

In some embodiments, the method further comprises configuring at least one of any one or more of: a bandwidth or frequency range over which the set of sensors detects the inter-network interference condition, a center frequency at which the set of sensors detects the inter-network interference condition, a quantity in terms of which the set of sensors detects the inter-network interference condition, and an interval at which the set of sensors detects the inter-network interference condition.

In some embodiments, adapting TDD configuration is further based on weights respectively assigned to sensors in the set.

In some embodiments, adapting TDD configuration of the one or more radio network nodes comprises adapting, based on the determined inter-network interference condition, a combination of TDD patterns with which multiple radio network nodes in the wireless communication network are configured.

In some embodiments, adapting TDD configuration of the one or more radio network nodes comprises adapting TDD configuration of the one or more radio network nodes further based on traffic to be communicated in the wireless communication network.

In some embodiments, the inter-network interference condition characterizes cross-link interference to the wireless communication network from one or more other wireless communication networks.

In some embodiments, the inter-network interference condition characterizes at least out-of-band interference to the wireless communication network from one or more other wireless communication networks.

In some embodiments, at least some of the sensors in the set are deployed at fixed locations within the coverage area of the wireless communication network. Additionally or alternatively, at least some of the sensors in the set are dedicated to detecting inter-network interference conditions.

In some embodiments, the wireless communication network is an industrial internet-of-things, IoT, network.

Other embodiments herein include network equipment configured for use in a wireless communication network. The network equipment is configured to determine an inter-network interference condition measured by a set of sensors deployed in a coverage area of the wireless communication network. In this case, the inter-network interference condition characterizes interference to the wireless communication network from one or more other wireless communication networks. The network equipment is also configured to adapt, based on the determined inter-network interference condition, time division duplexing, TDD, configuration of one or more radio network nodes in the wireless communication network.

In some embodiments, network equipment is configured to perform the steps described above for network equipment.

Other embodiments herein include a computer program comprising instructions which, when executed on at least one processor of network equipment, cause the network equipment to perform the steps described above for network equipment.

In some embodiments, a carrier containing the computer program comprises one of an electronic signal, optical signal, radio signal, or computer readable storage medium.

Other embodiments herein include network equipment configured for use in a wireless communication network. The network equipment comprises processing circuitry configured to determine an inter-network interference condition measured by a set of sensors deployed in a coverage area of the wireless communication network. In this case, the inter-network interference condition characterizes interference to the wireless communication network from one or more other wireless communication networks. The processing circuitry is also configured to adapt, based on the determined inter-network interference condition, time division duplexing, TDD, configuration of one or more radio network nodes in the wireless communication network.

In some embodiments, the processing circuitry is configured to perform the steps described above for network equipment.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2A is a block diagram of a time division duplexing (TDD) configuration controller according to some embodiments.

FIG. 2B is a block diagram of model usable by network equipment for TDD configuration adaptation according to some embodiments.

FIG. 3 is a block diagram of an example model usable by network equipment for TDD configuration adaptation according to some embodiments.

FIG. 4 is a block diagram of model usable by network equipment for TDD configuration adaptation according to other embodiments.

FIG. 5 is a block diagram of TDD configuration adaptation according to some embodiments.

FIG. 6A is a logic flow diagram of a method performed by network equipment according to some embodiments.

FIG. 6B is a logic flow diagram of a part of the method performed by network equipment in FIG. 6A, according to some embodiments.

FIG. 7 is a block diagram of network equipment according to some embodiments.

FIG. 8 is a block diagram of a wireless communication network according to some embodiments.

FIG. 9 is a block diagram of a user equipment according to some embodiments.

FIG. 10 is a block diagram of a virtualization environment according to some embodiments.

### DETAILED DESCRIPTION

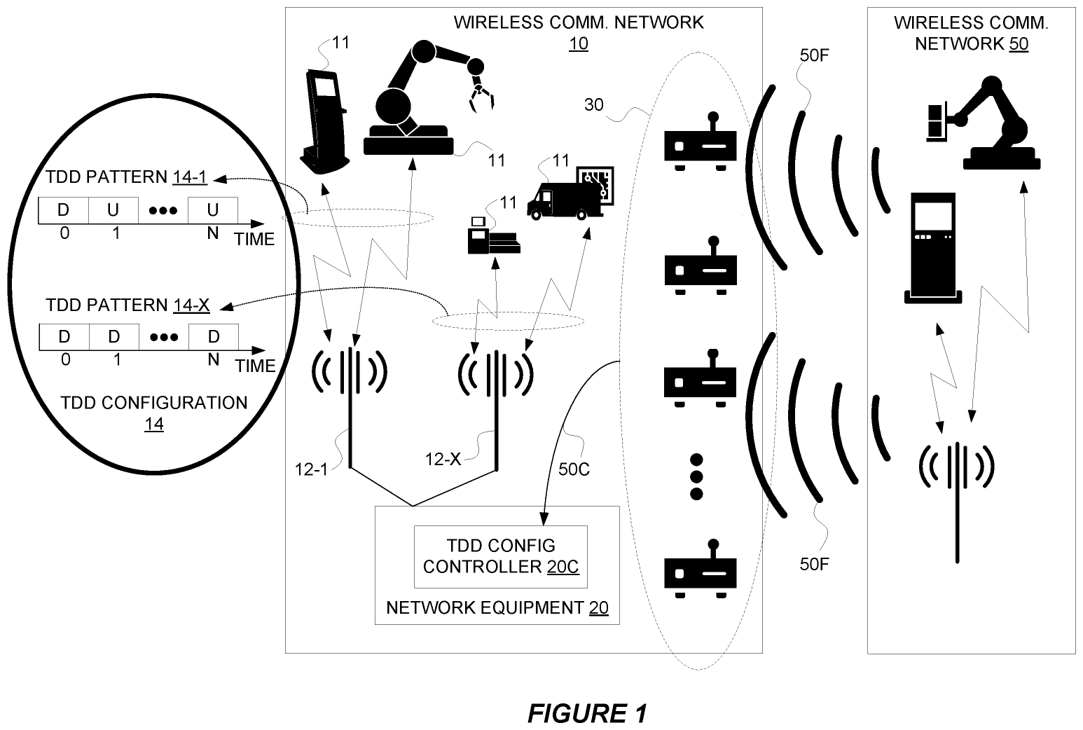

FIG. 1 shows a wireless communication network 10 that provides wireless communication service to communication equipment 11. The wireless communication network 10 includes one or more radio network nodes 12, two of which are shown as radio network node 12-1 and radio network node 12-X. The radio network node(s) 12 provide wireless communication coverage over a coverage area of the wireless communication network 10. For example, where the wireless communication network 10 is an industrial internet-of-things (IoT) network, the radio network node(s) 12 may provide wireless communication coverage to industrial IoT equipment over the geographic footprint of a factory.

The radio network node(s) 12 each transmit and receive in the wireless communication network 10 using time division duplex (TDD) operation. In TDD operation, the radio network node(s) 12 each time-multiplexes uplink and downlink transmissions, e.g., on the same frequency band. For example, the wireless communication network 10 may structure radio resources usable for transmission into radio frames, with each radio frame divided into uplink and downlink subframes that are time-multiplexed within each radio frame. In these and other embodiments, a TDD pattern defines which times (e.g., which subframes within a radio frame) are usable for downlink transmission and which times (e.g., which subframes within a radio frame) are usable for uplink transmission.

As shown in the example of FIG. 1, for instance, each of the radio network node(s) 12 multiplexes downlink and uplink transmissions within subframes 0-N according to a respective TDD pattern, e.g., where one radio frame includes N subframes. FIG. 1 shows that radio network node 12-1 is configured with TDD pattern 14-1 which defines subframe 0 as a downlink subframe usable for downlink transmission, subframe 1 as an uplink subframe for uplink transmission, subframe N as an uplink subframe for uplink transmission, etc. By contrast, radio network node 12-X is configured with TDD pattern 14-X, which defines subframe 0 as a downlink subframe usable for downlink transmission, subframe 1 as a downlink subframe for downlink transmission, subframe N as a downlink subframe for downlink transmission, etc.

In some embodiments, this TDD operation of the radio network node(s) 12 is dynamic, as opposed to semi-static. The dynamic nature of the TDD operation may mean, for instance, that the TDD pattern(s) 14-1 . . . 14-X with which the radio network node(s) 12-1 . . . 12-X are respectively configured may be adapted as needed to meet instantaneous traffic demand. In these and other embodiments, the TDD patterns 14-1 . . . 14-X may be adapted with full flexibility regarding which times are used for uplink transmission and which times are used for downlink transmission. For example, rather than the candidate TDD patterns usable by a radio network node being limited to a predefined subset of candidate TDD patterns, where all candidate TDD patterns in the subset have certain subframe(s) that must be used for downlink transmission and/or certain subframe(s) that must be used for uplink transmission, the candidate TDD patterns usable by a radio network node may extend to all possible TDD patterns. In this case, then, any subframe can be used for downlink transmission and any subframe can be used for uplink transmission. Moreover, in some embodiments, TDD pattern selection may be performed on a radio network node by radio network node basis, e.g., such that the TDD pattern used by each radio network node can be specifically tailored to that radio network node's instantaneous traffic demand, without limitations imposed by the TDD pattern used by another radio network node.

In this context, network equipment 20 shown in FIG. 1 adapts TDD configuration 14 of the radio network node(s) 12 in the wireless communication network 10, e.g., based on the instantaneous traffic demand imposed on the radio network node(s) 12. Such TDD configuration adaptation may be performed by a TDD configuration (config) controller 20C depicted in FIG. 1. Regardless, adapting TDD configuration 14 of the radio network node(s) 12 may involve adapting the TDD pattern(s) 14-1 . . . 14-X with which the radio network node(s) 12 are configured. In embodiments where network equipment 20 adapts TDD configuration 14 of multiple radio network nodes 12, adapting TDD configuration 14 of the radio network nodes 12 may more specifically involve adapting the combination of TDD patterns 14-1 . . . 14-X with which the radio network nodes 12 are respectively configured.

Notably, network equipment 20 adapts TDD configuration 14 of the radio network node(s) 12 in a way that accounts for interference 50F from one or more other wireless communication networks 50, e.g., providing wireless communication services to one or more neighboring factory halls. Such interference 50F may appropriately be referred to as inter-network interference, e.g., in the form of so-called cross-link interference (CLI) and/or out-of-band interference. FIG. 1 for instance shows that one or more other wireless communication networks 50 may be deployed in proximity to wireless communication network 10, e.g., for providing wireless communication coverage to a neighboring factory or factory floor. And the wireless communication networks 10, 50 each adapt TDD configuration independently, in an uncoordinated way, such that the combination of TDD patterns used in the wireless communication network 10 are not synchronized with the combination of TDD patterns used in the other wireless communication network(s) 50. The autonomy that each wireless communication network 10, 50 has over the TDD patterns used provides each network with flexibility to tailor its used TDD patterns to the network's own instantaneous traffic demand, thereby minimizing latency and maximizing throughput. However, the lack of synchronization between the TDD patterns in the networks 10, 50 contributes to the interference 50F that the other network(s) 50 impose on wireless communication network 10. Rather than diminish the autonomy that wireless communication network 10 has over TDD configuration 14 of the radio network node(s) 12, wireless communication network 10 employs network equipment 20 to adapt TDD configuration 14 of the radio network node(s) 12 based on the interference 50F from the other wireless communication network(s) 50.

Network equipment 20 in this regard exploits a set of sensors 30, e.g., in the form of a spectrum sensors. The set of sensors 30 is deployed in the wireless communication network's coverage area for measuring inter-network interference 50F from other wireless communication network(s) 50, e.g., in terms of power spectral density (PSD). Based on the measured inter-network interference 50F, the network equipment 20 adapts TDD configuration 14 of radio network node(s) 12 in the wireless communication network 10. Adapting TDD configuration 14 to account for measured inter-network interference 50F in this way may advantageously enable the network 10 to retain flexibility and autonomy over its TDD configuration while also mitigating the impact of the inter-network interference 50F on latency and throughput. Some embodiments may thereby be particularly applicable for exploiting dynamic TDD with low latency in mission-critical applications or industrial internet-of-things (IoT).

In any event, FIG. 1 more particularly shows that the set of sensors 30 is deployed in the wireless communication network's coverage area for measuring an inter-network interference condition 50C that characterizes the interference 50F to the wireless communication network 10 from the other wireless communication network(s) 50. The measured inter-network interference condition 50C may for instance characterize the interference 50F in terms of a combination of interference measurements performed by respective sensors 30 in the set, e.g., such that the combination of interference measurements across the sensors 30 in the set serves as a signature or fingerprint of the interference 50F experienced by the wireless communication network 10 at any given time and/or in any given frequency range. The sensors 30 in the set may for instance perform measurements of the interference 50F in the same frequency band as that used by the wireless communication network 10 and/or outside of the frequency band used by the wireless communication network 10.

Indeed, in some embodiments, interference measurements performed by the sensors 30 in the set may be performed in an out-of-band frequency range that is out of the frequency band(s) used by the wireless communication network 10 for communication with its served communication equipment 11, e.g., such that the interference measurements may effectively sample the cross-channel or cross-link interference coming from the other wireless communication network(s) 50. In these and other embodiments, the sensors 30 in the set are not themselves communication equipment 11 served by the wireless communication network 10, as the communication equipment 11 may only be capable of measuring and reporting interference on time-frequency resources used for wireless communication service from the network 10. Rather, the sensors 30 in the set may in some embodiments be dedicated to performing measurements for characterizing inter-network interference 50F.

Alternatively or additionally, in some embodiments, at least some of the sensors 30 in the set are deployed at fixed locations within the wireless communication network's coverage area. This way, the network equipment 20 can understand the inter-network interference condition 50C measured by the set of sensors 30 at any given time as being attributable to changes in the interference levels, e.g., as opposed to changes in the location of the sensors 30. In other embodiments, though, at least some of the sensors 30 in the set may be deployed at locations known to the network equipment 20, so that the network equipment 20 can interpret the inter-network interference condition 50C measured by the set of sensors 30 at any given time as a function of the sensors' respective locations at that time.

Regardless, based on the inter-network interference condition 50C measured by the set of sensors 30, the network equipment 20 adapts TDD configuration 14 of the radio network node(s) 12 in the wireless communication network 10. For example, based on the inter-network interference condition 50C, the network equipment 20 may adapt the TDD pattern with which a radio network node 12 is configured, e.g., in which case the network equipment 20 may be the radio network node itself. Or, based on the inter-network interference condition 50C, the network equipment may adapt the combination of TDD patterns 14-1 . . . 14-X with which multiple radio network nodes 12-1 . . . 12-X are respectively configured, e.g., in which case the network equipment 20 may be one of the radio network nodes or may be other equipment. Regardless, the network equipment 20 may adapt TDD configuration 14 of the radio network node(s) 12 as needed to mitigate the impact of the inter-network interference 50F on the performance of transmissions to and/or from the radio network node(s) 12, e.g., in terms of one or more performance metrics, such as sum-throughput. That is, the network equipment 20 may adapt TDD configuration 14 of the radio network node(s) 12 as needed so that, under the measured inter-network interference condition 50C, a performance target or objective (e.g., maximum sum-throughput) is met.

More particularly, in some embodiments, the network equipment 20 models performances that are achievable, under various possible inter-network interference conditions, with different TDD configurations which are candidates for selection. The network equipment 20 dynamically selects a candidate TDD configuration which achieves a performance objective (e.g., max sum-throughput) under an inter-network interference condition that corresponds to (e.g., is similar to) the current inter-network condition 50C measured by the set of sensors 30.

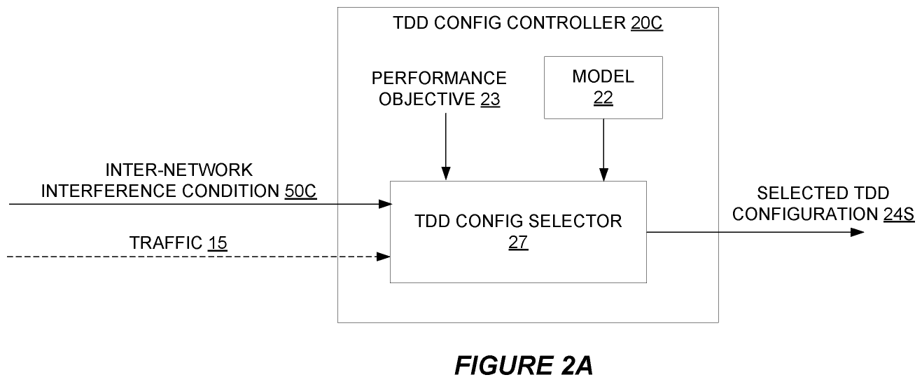

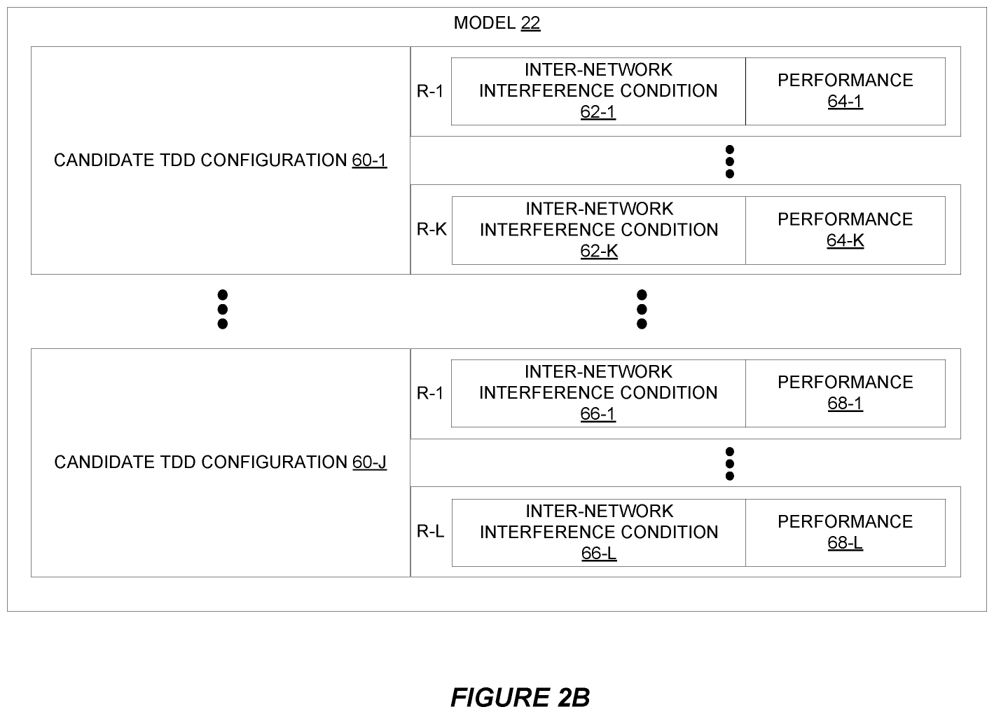

FIGS. 2A-2B show one example according to some embodiments. The TDD configuration controller 20C of the network equipment 20 includes a TDD configuration selector 27 that obtains a model 22, e.g., a labeled dataset or a machine learning model. The model 22 models, for each of multiple candidate TDD configurations of the radio network node(s) 12, performance achievable with the candidate TDD configuration under different inter-network interference conditions.

In some embodiments, the model 22 is specific to a certain radio network node. In this case, the candidate TDD configurations in the model 22 are candidate TDD patterns with which the certain radio network node is configurable. In other embodiments, by contrast, the model 22 is applicable for a group of multiple network nodes 12, e.g., within a part of or all of the wireless communication network 10. In this case, the candidate TDD configurations in the model 22 are candidate combinations of TDD patterns with which the radio network nodes 12 in the group are configurable.

Regardless, equipped with this model 22, the TDD configuration selector 27 selects, from the candidate TDD configurations, a candidate TDD configuration 24S that, according to the model 22, achieves a performance objective 23 under an inter-network interference condition corresponding to the inter-network interference condition 50C measured by the set of sensors 30. In some embodiments, the TDD configuration selector 27 selects the candidate TDD configuration 24S based further on the traffic 15 to be communicated in the wireless communication network 10. Regardless, the TDD configuration controller 20C then configures the radio network node(s) 12 with the selected candidate TDD configuration 24S.

FIG. 2B shows additional details of the model 22 according to some embodiments. As shown, the model 22 models, for each of multiple candidate TDD configurations 60-1 . . . 60-J of the radio network node(s) 12, performance achievable with the candidate TDD configuration under different inter-network interference conditions.

The model 22 in this regard comprises one or more measurement records for each candidate TDD configuration 60-1 . . . 60-J. Each measurement record for a candidate TDD configuration comprises a measurement of performance achieved with the candidate TDD configuration and a measurement of an inter-network interference condition under which the performance was measured.

As shown, for instance, the model 22 includes measurement records R-1 . . . R-K for candidate TDD configuration 60-1. Measurement record R-1 indicates that candidate TDD configuration 60-1 achieves performance 64-1 under inter-network interference condition 62-1, whereas measurement record R-K indicates that candidate TDD configuration 60-1 achieves performance 64-K under inter-network interference condition 62-K. The model as shown also includes measurement records R-1 . . . R-L for candidate TDD configuration 60-J.

Measurement record R-1 indicates that candidate TDD configuration 60-J achieves performance 68-1 under inter-network interference condition 66-1, whereas measurement record R-L indicates that candidate TDD configuration 60-J achieves performance 68-L under inter-network interference condition 66-L.

In embodiments where the model 22 is specific to a certain radio network node. the candidate TDD configurations 60-1 . . . 60-J in the model 22 are candidate TDD patterns with which the certain radio network node is configurable, and the performances 64-1 . . . 64-K, 68-1 . . . 68-L characterize performances of transmissions to or from that certain radio network node. In other embodiments where the model 22 is applicable for a group of multiple network nodes 12, the candidate TDD configurations 60-1 . . . 60-J in the model 22 are candidate combinations of TDD patterns with which the radio network nodes 12 in the group are configurable, and the performances 64-1 . . . 64-K, 68-1 . . . 68-L characterize performances of transmissions collectively across the group of radio network nodes 12.

In some embodiments, the TDD configuration controller 20C trains or otherwise generates this model 22 based on successively configuring the radio network node(s) 12 with different ones of the candidate TDD configurations 60-1 . . . 60-J. While the radio network node(s) 12 are configured with each candidate TDD configuration, the TDD configuration controller 20C collects measurement(s) of the resulting performance(s) achieved with that TDD configuration, and collects from the set of sensors 30 measurement(s) of the inter-network interference condition(s) under which the performance(s) are measured. So, for example, the TDD configuration controller 20C configures the radio network node(s) 12 with candidate TDD configuration 60-1, collects a measurement of the performance 64-1 achieved with that candidate TDD configuration 60-1, and collects a measurement of the inter-network interference condition 62-1 under which the performance 64-1 was measured. The TDD configuration controller 20C may take multiple samples of the performance achieved with this candidate TDD configuration 60-1 over time, in order to identify the performance achieved with the candidate TDD configuration 60-1 under different inter-network interference conditions 62-1 . . . 62-K. At some time later in this regard, then, the TDD configuration controller 20C may again configure the radio network node(s) 12 with candidate TDD configuration 60-1, collect a measurement of the performance 64-K achieved this time with that candidate TDD configuration 60-1, and collect a measurement of the inter-network interference condition 62-K under which the performance 64-K was measured (which may be different than the inter-network interference condition 62-1 under which the performance 64-1 of candidate TDD configuration 60-1 was measured previously). In this way, the model 22 reflects the performances 64-1 . . . 64-K that the candidate TDD configuration 60-1 achieves under respective inter-network interference conditions 62-1 . . . 62-K. The TDD configuration controller 20C may proceed similarly with respect to one or more other candidate TDD configurations. In particular, the TDD configuration controller 20C configures the radio network node(s) 12 with candidate TDD configuration 60-J, collects a measurement of the performance 68-1 achieved with that candidate TDD configuration 60-J, and collects a measurement of the inter-network interference condition 66-1 under which the performance 68-1 was measured (which may be the same as or different than one of the inter-network interference conditions 62-1 . . . 62-K under which the performances 64-1 . . . 64-K of candidate TDD configuration 60-1 was measured). At some time later, the TDD configuration controller 20C may again configure the radio network node(s) 12 with candidate TDD configuration 60-J, collect a measurement of the performance 68-L achieved this time with that candidate TDD configuration 60-J, and collect a measurement of the inter-network interference condition 66-L under which the performance 68-L was measured (which may be different than the inter-network interference condition 66-1 under which the performance 68-1 of candidate TDD configuration 60-J was measured previously).

Note here that, in some embodiments, the model 22 models the performances of the candidate TDD configurations 60-1 . . . 60-J under, or based on, whatever inter-network interference conditions the wireless communication network 10 experiences during model training. The inter-network interference conditions 62-1 . . . 62-K, 66-1 . . . 66-L reflected in the model 22 may therefore not include every possible inter-network interference condition that the wireless communication network 10 might experience later on when using the model 22 to select a candidate TDD configuration with which to configure the radio network node(s) 12.

Accordingly, when the set of sensors 30 later on measures the current inter-network interference condition 50C and the network equipment 20 uses the model 22 to select which candidate TDD configuration to use under that inter-network interference condition 50C, the TDD configuration selector 27 in some embodiments determines which measurement record(s) R-1 . . . R-K, R-1 . . . R-L in the model 22 include a measurement of an inter-network interference condition that is similar to the current inter-network interference condition 50C, e.g., according to similarity criteria, such as a distance metric. The TDD configuration selector 27 may then select, from among measurement record(s) that include a measurement of an inter-network interference condition that is similar to the current inter-network interference condition 50C, a measurement record that includes a measurement of performance meeting a performance target (e.g., maximum sum-throughput). The TDD configuration selector 27 may correspondingly select the candidate TDD configuration for which the selected measurement record was obtained. For instance, if the inter-network interference conditions 62-K and 66-L in FIG. 2B are similar to the current inter-network interference condition 50C, the TDD configuration selector 27 may select, from among measurement records R-K and R-L, whichever measurement record's performance 64-K, 68-L maximizes sum-throughput. If the TDD configuration selector 27 selects measurement record R-K, the TDD configuration selector 27 would then select candidate TDD configuration 60-1 as the candidate TDD configuration 24S with which to configure the radio network node(s) 12.

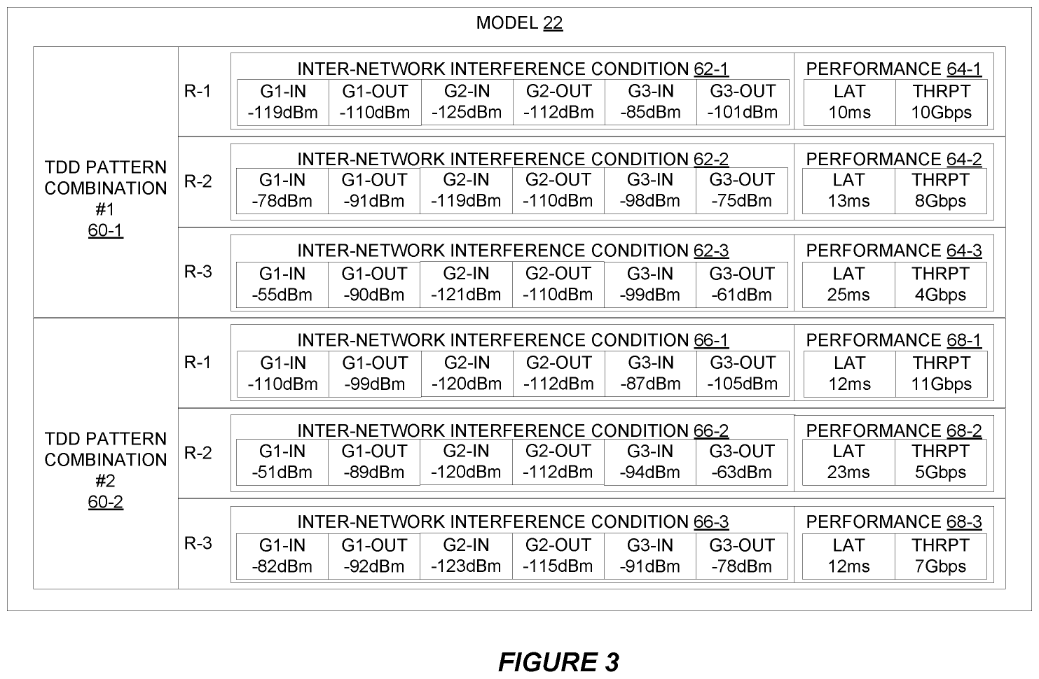

FIG. 3 shows a concrete example for illustrating some embodiments herein. In this example, the candidate TDD configurations include two combinations of TDD patterns with which radio network nodes 12 are configurable, including TDD pattern combination #1 60-1 and TDD pattern combination #2 60-2. The model 22 includes three measurement records R-1, R-2, and R-3 for TDD pattern combination #1, and three measurement records R-1, R-2, and R-3 for TDD pattern combination #2. Each measurement record characterizes an inter-network interference condition in terms of a combination of interference levels measured by a set of three sensors G1, G2, and G3, and characterizes performance in terms of latency (lat) and throughput (thrpt). In particular, the first measurement record R-1 for TDD pattern combination #1 indicates that TDD combination #1 achieves a latency of 10 ms and a throughput of 10 Gbps when sensors G1, G2, and G3 measure a certain combination of interference levels; namely, when sensor G1 measures an in-band interference level (G1-IN) of −119 dBm and measures an out-of-band interference level (G1-OUT) of −110 dBm, G2 measures an in-band interference level (G2-IN) of −125 dBm and measures an out-of-band interference level (G2-OUT) of −112 dBm, and G3 measures an in-band interference level (G3-IN) of −85 dBm and measures an out-of-band interference level (G3-OUT) of −101 dBm: {G1-IN: −119 dBm, G1-OUT: −110 dBm, G2-IN: −125 dBm, G2-OUT: −112 dBm, G3-IN: −85 dBm, G3-OUT: −101 dBm}. Similarly, the second measurement record R-2 for TDD pattern combination #1 indicates that TDD combination #1 achieves a latency of 13 ms and a throughput of 8 Gbps when sensors G1, G2, and G3 measure a different combination of interference levels; namely, when sensor G1 measures an in-band interference level (G1-IN) of −78 dBm and measures an out-of-band interference level (G1-OUT) of −91 dBm, G2 measures an in-band interference level (G2-IN) of −119 dBm and measures an out-of-band interference level (G2-OUT) of −110 dBm, and G3 measures an in-band interference level (G3-IN) of −98 dBm and measures an out-of-band interference level (G3-OUT) of −75 dBm: {G1-IN: −78 dBm, G1-OUT: −91 dBm, G2-IN: −119 dBm, G2-OUT: −110 dBm, G3-IN: −98 dBm, G3-OUT: −78 dBm}. And so on.

In the example of FIG. 3, then, assume that the set of sensors G1, G2, and G3 measures a current inter-network interference condition 50C of {G1-IN: −115 dBm, G1-OUT: −105 dBm, G2-IN: −123 dBm, G2-OUT: −112 dBm, G3-IN: −86 dBm, G3-OUT: −103 dBm}. The TDD configuration controller 27 in this case identifies that the inter-network interference conditions most similar to the current inter-network interference condition 50C are inter-network interference condition 62-1 associated with measurement record R-1 for TDD pattern combination #1 60-1 and inter-network interference condition 66-1 associated with measurement record R-1 for TDD pattern combination #2 60-2. The TDD configuration selector 27 therefore selects between TDD pattern combinations #1 and #2 based on a comparison of the respective performances 64-1 and 68-1 achievable with those combinations under the similar inter-network interference conditions 62-1, 66-1. Since TDD pattern combination #1 achieves a lower latency (10 ms) and a higher throughput (10 Gbps) under inter-network interference condition 62-1, as compared to the latency (12 ms) and throughput (11 Gbps) achievable with TDD pattern combination #2 under inter-network interference condition 66-1, the TDD configuration selector 27 may select TDD pattern combination #1.

Note that the different inter-network interference conditions and performances achievable thereunder may be measured while the targeted wireless communication service is offline and/or while the targeted wireless communication service is online. For example, where the targeted wireless communication service is business-critical wireless communication service for a factory, the different inter-network interference conditions and performances achievable thereunder may be measured while that business-critical wireless communication service is offline and/or while that business-critical wireless communication service is online, e.g., where non-business-critical wireless communication services may be online in either case.

In embodiments where the inter-network interference conditions and performances achievable thereunder are measured while the targeted wireless communication service is offline, the model 22 is correspondingly trained or otherwise generated offline, i.e., when targeted wireless communication service is not being actively provided by the wireless communication network 10. Such offline training may for example be performed before the targeted wireless communication service is operational, e.g., before factory operations start in an industrial IoT context. In this case, the TDD configuration controller 20C can successively configure the radio network node(s) 12 with all of the different candidate TDD configurations, measure the performance achievable with each, and measure the inter-network interference condition under which that performance measurement was made. Even if there are a large number of possible TDD configurations, this offline training may nonetheless be performed fairly quickly, since performance may be measured over a short period of time, e.g., transmissions whose performance are measured may be on the order of a few milliseconds.

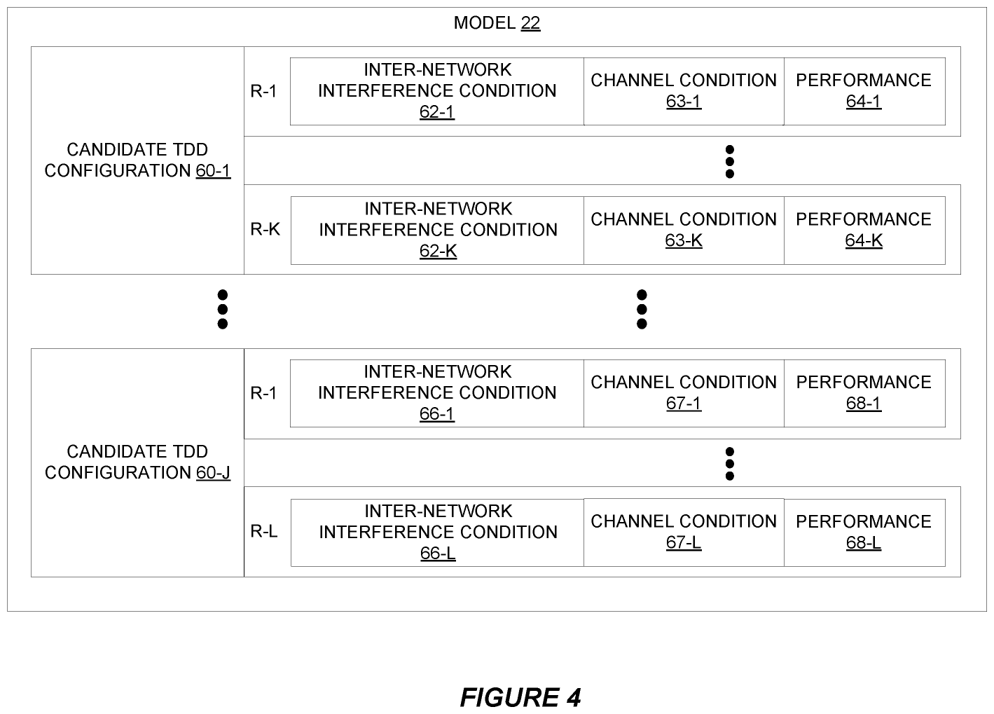

In embodiments where the inter-network interference conditions and performances achievable thereunder are measured while the targeted wireless communication service is online, the model 22 is correspondingly trained or otherwise generated online, i.e., when targeted wireless communication service is being actively provided by the wireless communication network 10. In some of these embodiments, then, the model 22 may be trained or generated also based on measurements performed by wireless devices being provided the targeted wireless communication service. Such measurements may include, for instance, measurements of reference signals and/or synchronization signals transmitted to or from the wireless device(s), where such measurements represent measurement of a channel condition at the wireless device(s), e.g., in the form of Channel State Information (CSI) feedback. The measurement records of the model 22 may, for example, each also comprise a measurement of a channel condition, as measured by the wireless device(s) being provided the targeted wireless communication service, under which performance was measured. FIG. 4 shows one example.

As shown in FIG. 4, each of the measurement records R1 . . . R-K, R-1 . . . R-L in the model 22 also includes a measurement of a channel condition at one or more wireless devices under which the respective performance was measured. In particular, the model 22 includes measurement records R-1 . . . R-K for candidate TDD configuration 60-1. Measurement record R-1 indicates that candidate TDD configuration 60-1 achieves performance 64-1 under inter-network interference condition 62-1 and channel condition 63-1, whereas measurement record R-K indicates that candidate TDD configuration 60-1 achieves performance 64-K under inter-network interference condition 62-K and channel condition 63-K. The model as shown also includes measurement records R-1 . . . R-L for candidate TDD configuration 60-J. Measurement record R-1 indicates that candidate TDD configuration 60-J achieves performance 68-1 under inter-network interference condition 66-1 and channel condition 67-1, whereas measurement record R-L indicates that candidate TDD configuration 60-J achieves performance 68-L under inter-network interference condition 66-L and channel condition 67-L.

In these embodiments, then, the TDD configuration selector 27 may determine which measurement record(s) R-1 . . . R-K, R-1 . . . R-L in the model 22 include a measurement of an inter-network interference condition that is similar to the current inter-network interference condition 50C and include a measurement of a channel condition that is similar to the current channel condition reported, e.g., according to similarity criteria, such as a distance metric. The TDD configuration selector 27 may then select, from among measurement record(s) that include a measurement of an inter-network interference condition that is similar to the current inter-network interference condition 50C and include a measurement of a channel condition that is similar to the current channel condition, a measurement record that includes a measurement of performance meeting a performance target (e.g., maximum sum-throughput). The TDD configuration selector 27 may correspondingly select the candidate TDD configuration for which the selected measurement record was obtained.

Generally, though, the network equipment 20 according to some embodiments may select, from the candidate TDD configurations, a candidate TDD configuration that, according to the model 22, achieves a performance objective (e.g., maximize network-wide sum-throughput), while meeting one or more performance constraints (e.g., a bounded latency and minimum throughput per device/user), under an inter-network interference condition corresponding to the current inter-network interference condition 50C. In these and other embodiments, the TDD configuration selector 27 may effectively find the candidate TDD configuration that optimizes the following tasks:

$${argmax}_{{T}_{𝟙} , … , {T}_{L}} Q$$

$$s . t {μ}_{1} , … , {μ}_{K} <> {Δ}_{1}$$

$${θ}_{1} , … , {θ}_{K} > {Δ}_{2}$$

Here, T₁, . . . , T_{L} indicates the combination of TDD patterns for L cells or base stations in the network 10 that minimizes the total inter-network interference 50F. Q is a performance objective variable (e.g., the sum-throughput of the network 10, signal-to-noise-plus-interference-ratio (SINR), etc.). The constraints ensure a bounded latency, μ, and minimum throughput, θ, for each of the K users. Δ₁ and Δ₂ denotes the bounded latency and minimum throughput values. The performance objective variable, the bounded latency, and the minimum throughput are determined based on the traffic 15 to be communicated to or from the radio network node(s) 12.

In some embodiments, the optimization tasks further take into account which resources are to be allocated to which wireless device(s) for the communication to or from the radio network node(s) 12. In this case, then, the TDD configuration selector 27 may effectively find the candidate TDD configuration that optimizes the following tasks:

$${argmax}_{{T}_{𝟙} , … , {T}_{L} , {R}_{𝟙} , … , {R}_{K}} Q$$

$$s . t {μ}_{1} , … , {μ}_{K} <> {Δ}_{1}$$

$${θ}_{1} , … , {θ}_{K} > {Δ}_{2}$$

Here, R₁, . . . , R_{K} indicates the resources allocated to respective ones of the K users. Accordingly, T₁, . . . , T_{L}, R₁, . . . , R_{K} indicates the combination of TDD patterns for L cells or base stations in the network 10 and the combination of resources for the K users that minimizes the total inter-network interference 50F.

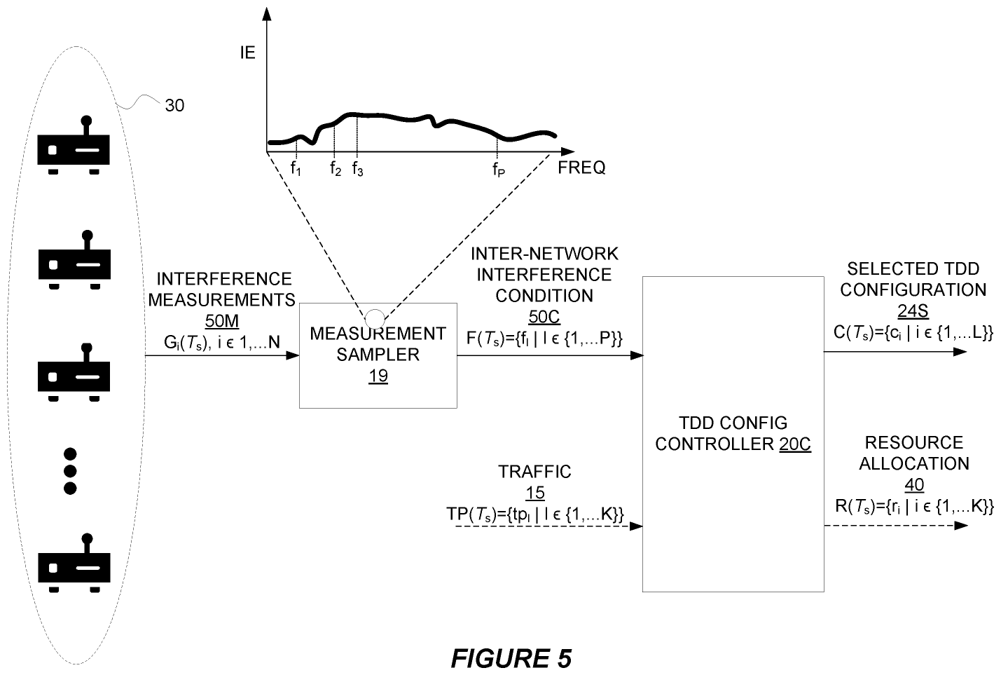

FIG. 5 shows a high-level view of these and other embodiments herein. As shown, a measurement sampler 19 (e.g., implemented by network equipment 20) receives measurements 50M of the inter-network interference energy (IE) from N sensors 30, e.g., represented as Gᵢ(Tₛ), iϵ1, . . . N. The measurement sampler 19 samples those measurements in the frequency domain, e.g., at P frequencies f1, f2, f3, . . . fP, in order to determine the inter-network interference condition 50C characterized by those measurements, e.g., represented as F(Ts)={fI|Iϵ{1, . . . P}} where Ts denotes the rate at which the sensors 30 are sampled. The TDD configuration controller 20C receives this inter-network interference condition 50C and optionally a profile of the traffic 15 (traffic profile, TP) associated with each of K users 12, e.g., represented as TP(Ts)={tpI|Iϵ{1, . . . K}}. Based on the inter-network interference condition 50C and optionally the profile of traffic 15, the TDD configuration controller 20C selects the TDD configuration 24S with which to configure L radio network node 12, e.g., represented as C(Ts)={ci|iϵ{1, . . . L}}. In some embodiments, the TDD configuration controller 20C selects this TDD configuration 24 jointly with a resource allocation 40 for the K users e.g., represented as R(Ts)={ri|iϵ{1, . . . K}}. Broadly, then, the TDD configuration controller 20C maps the inter-network interference condition 50C and optionally the profile of traffic 15 to a TDD configuration 24S for the L radio network nodes/cells and, optionally, a resource allocation R for the K users.

Note that, in some embodiments, at least some of the sensors 30 in the set are configurable with regard to one or more sensor properties. For example, in some embodiments, the network equipment 20 may configure one or more of: a bandwidth or frequency range over which the set of sensors 30 detects the inter-network interference condition 50C, a center frequency at which the set of sensors 30 detects the inter-network interference condition 50C, a quantity (e.g., signal strength, power, PSD, etc.) in terms of which the set of sensors 30 detects the inter-network interference condition 50C, and/or an interval at which the set of sensors 30 detects the inter-network interference condition 50C. Alternatively or additionally, the network equipment 20 may configure the sensors 30 to provide different types of information, e.g., in-band power levels, adjacent channel power levels, different bandwidth selection, different averaging periods, etc. In some embodiments, the sensors 30 can be configured by the network equipment 20 or preconfigured as needed in these respects. In fact, in some embodiments, the network equipment 20 configures the sensors 30 with different configurations while training the model 22, so that the model 22 reflects different combinations of inter-network interference conditions and performances under different sensor configurations. This way, the network equipment 20 may adapt TDD configuration 14 based also on configuration of the sensors 30, e.g., such that the configuration of the sensors 30 is also an optimization task based on which TDD configuration selection is performed.

That said, in some embodiments, not all of the sensors 30 are configurable by the network equipment 20. In one embodiment, for example, at least one of the sensors 30 is preconfigured, e.g., by an owner of the factory for which the wireless communication network 10 provides coverage. In this case, others of the sensors 30 may be dynamically configured as needed by the network equipment 20, e.g., by base station decisions.

Note, too, that in some embodiments at least some sensors 30 in the set may be prioritized higher or lower than at least some others of the sensors 30 in the set, e.g., with regard to the extent to which measurements impact the inter-network interference condition 50C based on which TDD configuration 14 adaptation is performed. In one embodiment, for example, weights are respectively assigned to sensors 30 in the set. Weights may be assigned for instance based on the importance of respective sensors to the optimization task, the spatial proximity of respective sensors to devices that execute the targeted wireless communication service (e.g., time-critical services), or the like. In such embodiments, the network equipment 20 adapts TDD configuration 14 based further on these weights.

In any event, embodiments herein may generally exploit dedicated and/or configurable sensors 30 to obtain spectrum sensing information that helps to (understand and) minimize cross-link interference and/or near-far interference. The sensors 30 in this regard may provide a signature of such interference, e.g., by providing multi-grade spectrum sensing at a given location in a selected bandwidth (co-channel, cross-channel). The network equipment 20 herein may dynamically select an optimal TDD configuration (e.g., one TDD pattern or a combination of TDD patterns), e.g., specific for an industrial IoT use-case. For example, the network equipment 20 (e.g., in the form of a base station) may select the TDD configuration based on channel feedback from user equipments (UEs) and the inputs from sensors 30 that aim to maximize the QoS requirements at UEs. The network equipment 20 may then correspondingly assign the selected TDD configuration and allocate resources to UEs accordingly. In these and other embodiments, the network equipment 20 may choose an appropriate dynamic TDD configuration that is resilient to the impact of external interference from neighboring networks, using sensors 30 that are dedicated and/or configurable. Such TDD configuration selection may thereby provide the uplink-downlink split that is appropriate in view of the sensed interference. In these and other embodiments, the sensors 30 may be located at known locations and/or can be configured by the network equipment 20 for specific spectrum sensing metrics, e.g., bandwidth, center frequency, spectrum sensing quantity, and/or reporting interview.

Some embodiments correspondingly provide one or more of the following technical advantages. Some embodiments provide optimized TDD pattern selection to address the application quality of service (QoS) requirements, especially for industrial automation applications. The TDD pattern may thereby represent the application- and deployment scenario dependent actual traffic characteristics, e.g., in a given factory hall. Some embodiments provide reduced latency, enhanced reliability, and/or larger effective throughput. Alternatively or additionally, some embodiments provide interference mitigation and efficient use of spectral resources for specific cells. Alternatively or additionally, some embodiments optimize the network 10 to cater to the dynamics in the radio environment. Moreover, some embodiments use sensors 30 that are external for enhancing the capability of the wireless communication network 10 (e.g., a 3GPP-based system), without causing impact to telecommunication standards.

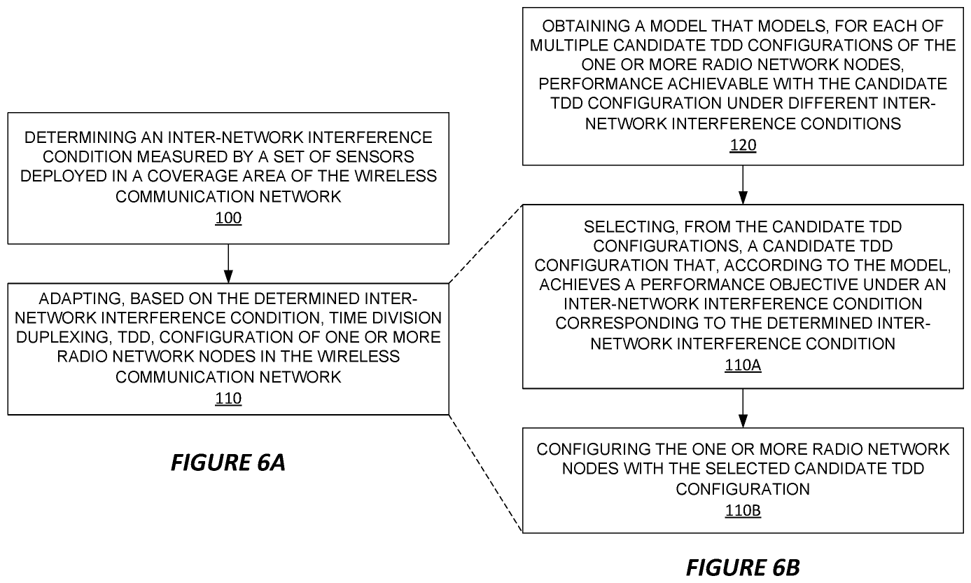

In view of the above modifications, FIG. 6A depicts a method performed by network equipment 20 configured for use in a wireless communication network 10 (e.g., an industrial IoT network) in accordance with particular embodiments. The method includes determining an inter-network interference condition 50C measured by a set of sensors 30 deployed in a coverage area of the wireless communication network 10 (Block 100). In some embodiments, the inter-network interference condition 50C characterizes interference 50F (e.g., cross-link interference and/or out-of-band interference) to the wireless communication network 10 from one or more other wireless communication networks 50. The method as shown further includes adapting, based on the determined inter-network interference condition 50C, time division duplexing (TDD) configuration 14 of one or more radio network nodes 12 in the wireless communication network 10 (Block 110). For example, in some embodiments, such adaptation comprises adapting, based on the determined inter-network interference condition 50C, a combination of TDD patterns 14-1 . . . 14-X with which respective radio network nodes 12-1 . . . 12-X in the wireless communication network 10 are configured.

In some embodiments, TDD configuration is adapted further based on traffic 15 to be communicated in the wireless communication network 10.

FIG. 6B illustrates additional aspects of the method in FIG. 6A according to some embodiments. As shown, the method in one embodiment further comprises obtaining a model 22 that models, for each of multiple candidate TDD configurations 60-1 . . . 60-J of the one or more radio network nodes 12, performance 64-1 . . . 64-K, 68-1 . . . 68-L achievable with the candidate TDD configuration under different inter-network interference conditions 62-1 . . . 62-K, 66-1 . . . 6-L. For example, in some embodiments, each candidate TDD configuration 60-1 . . . 60-J is a candidate combination of multiple TDD patterns with which to respectively configure multiple radio network nodes 12. Regardless, in some embodiments, the adapting step (Block 110) comprises selecting, from the candidate TDD configurations 60-1 . . . 60-J, a candidate TDD configuration 24S that, according to the model 22, achieves a performance objective under an inter-network interference condition corresponding to the determined inter-network interference condition 50C (Block 110A). In this case, adapting (Block 110) may further comprise configuring the one or more radio network nodes 12 with the selected candidate TDD configuration 24 (Block 110B).

Embodiments herein also include corresponding apparatuses. Embodiments herein for instance include network equipment 20 configured to perform any of the steps of any of the embodiments described above for the network equipment 20.

Embodiments also include a network equipment 20 comprising processing circuitry and power supply circuitry. The processing circuitry is configured to perform any of the steps of any of the embodiments described above for the network equipment 20. The power supply circuitry is configured to supply power to the network equipment 20.

Embodiments further include network equipment 20 comprising processing circuitry. The processing circuitry is configured to perform any of the steps of any of the embodiments described above for the network equipment 20. In some embodiments, the network equipment 20 further comprises communication circuitry.

Embodiments further include network equipment 20 comprising processing circuitry and memory. The memory contains instructions executable by the processing circuitry whereby the network equipment 20 is configured to perform any of the steps of any of the embodiments described above for the network equipment 20.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

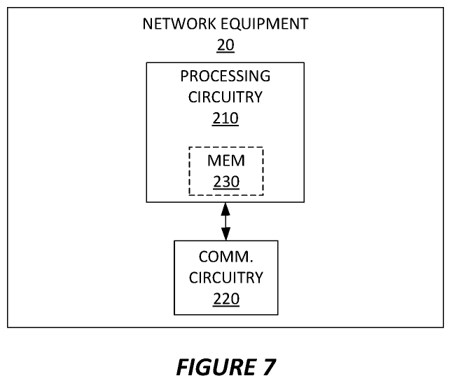

FIG. 7 for example illustrates network equipment 20 as implemented in accordance with one or more embodiments. As shown, the network equipment 20 includes processing circuitry 210 and communication circuitry 220. The communication circuitry 220 (e.g., radio circuitry) is configured to transmit and/or receive information to and/or from one or more other nodes, e.g., via any communication technology. The processing circuitry 210 is configured to perform processing described above, e.g., in FIGS. 6A and/or 6B, such as by executing instructions stored in memory 230. The processing circuitry 210 in this regard may implement certain functional means, units, or modules.

Those skilled in the art will also appreciate that embodiments herein further include corresponding computer programs.

A computer program comprises instructions which, when executed on at least one processor of network equipment 20, cause the network equipment 20 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of network equipment 20, cause the network equipment 20 to perform as described above.

Embodiments further include a computer program product comprising program code portions for performing the steps of any of the embodiments herein when the computer program product is executed by network equipment 20. This computer program product may be stored on a computer readable recording medium.

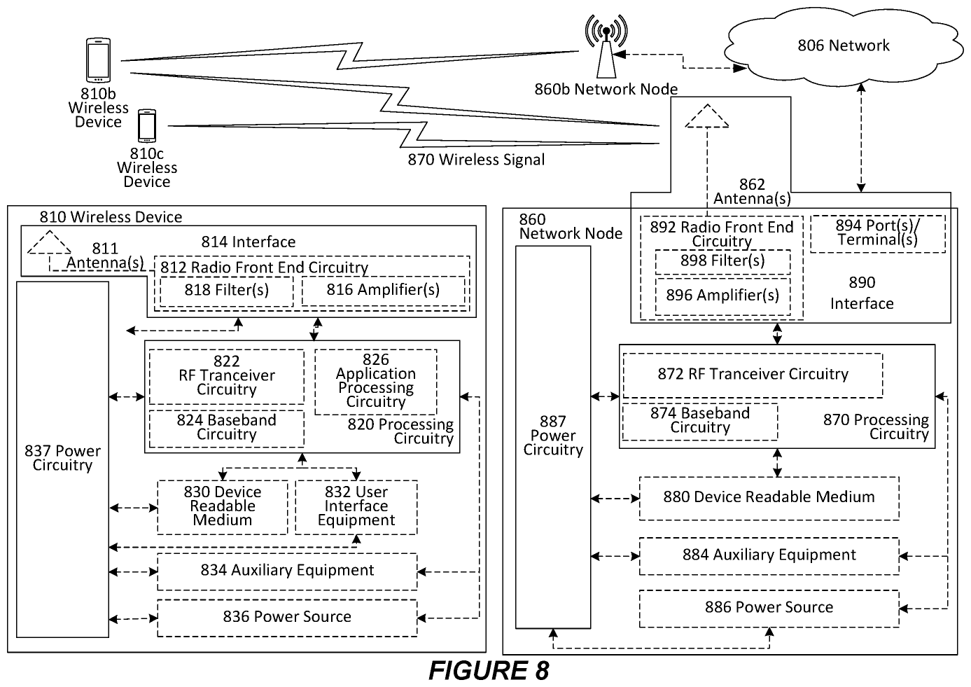

Although the subject matter described herein may be implemented in any appropriate type of system using any suitable components, the embodiments disclosed herein are described in relation to a wireless communication network 10, such as the example wireless network illustrated in FIG. 8. For simplicity, the wireless network of FIG. 8 only depicts network 806, network nodes 860 and 860b, and WDs 810, 810b, and 810c. In practice, a wireless network may further include any additional elements suitable to support communication between wireless devices or between a wireless device and another communication device, such as a landline telephone, a service provider, or any other network node or end device. Of the illustrated components, network node 860 and wireless device (WD) 810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 860 includes processing circuitry 870, device readable medium 880, interface 890, auxiliary equipment 884, power source 886, power circuitry 887, and antenna 862. Although network node 860 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 860 are depicted as single boxes located within a larger box, or nested within multiple boxes, in practice, a network node may comprise multiple different physical components that make up a single illustrated component (e.g., device readable medium 880 may comprise multiple separate hard drives as well as multiple RAM modules).

Similarly, network node 860 may be composed of multiple physically separate components (e.g., a NodeB component and a RNC component, or a BTS component and a BSC component, etc.), which may each have their own respective components. In certain scenarios in which network node 860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 860 may be configured to support multiple radio access technologies (RATs). In such embodiments, some components may be duplicated (e.g., separate device readable medium 880 for the different RATs) and some components may be reused (e.g., the same antenna 862 may be shared by the RATs). Network node 860 may also include multiple sets of the various illustrated components for different wireless technologies integrated into network node 860, such as, for example, GSM, WCDMA, LTE, NR, WiFi, or Bluetooth wireless technologies. These wireless technologies may be integrated into the same or different chip or set of chips and other components within network node 860.

Processing circuitry 870 is configured to perform any determining, calculating, or similar operations (e.g., certain obtaining operations) described herein as being provided by a network node. These operations performed by processing circuitry 870 may include processing information obtained by processing circuitry 870 by, for example, converting the obtained information into other information, comparing the obtained information or converted information to information stored in the network node, and/or performing one or more operations based on the obtained information or converted information, and as a result of said processing making a determination.

Processing circuitry 870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 860 components, such as device readable medium 880, network node 860 functionality. For example, processing circuitry 870 may execute instructions stored in device readable medium 880 or in memory within processing circuitry 870. Such functionality may include providing any of the various wireless features, functions, or benefits discussed herein. In some embodiments, processing circuitry 870 may include a system on a chip (SOC).

In some embodiments, processing circuitry 870 may include one or more of radio frequency (RF) transceiver circuitry 872 and baseband processing circuitry 874. In some embodiments, radio frequency (RF) transceiver circuitry 872 and baseband processing circuitry 874 may be on separate chips (or sets of chips), boards, or units, such as radio units and digital units. In alternative embodiments, part or all of RF transceiver circuitry 872 and baseband processing circuitry 874 may be on the same chip or set of chips, boards, or units

In certain embodiments, some or all of the functionality described herein as being provided by a network node, base station, eNB or other such network device may be performed by processing circuitry 870 executing instructions stored on device readable medium 880 or memory within processing circuitry 870. In alternative embodiments, some or all of the functionality may be provided by processing circuitry 870 without executing instructions stored on a separate or discrete device readable medium, such as in a hard-wired manner. In any of those embodiments, whether executing instructions stored on a device readable storage medium or not, processing circuitry 870 can be configured to perform the described functionality. The benefits provided by such functionality are not limited to processing circuitry 870 alone or to other components of network node 860, but are enjoyed by network node 860 as a whole, and/or by end users and the wireless network generally.

Device readable medium 880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 870. Device readable medium 880 may store any suitable instructions, data or information, including a computer program, software, an application including one or more of logic, rules, code, tables, etc. and/or other instructions capable of being executed by processing circuitry 870 and, utilized by network node 860. Device readable medium 880 may be used to store any calculations made by processing circuitry 870 and/or any data received via interface 890. In some embodiments, processing circuitry 870 and device readable medium 880 may be considered to be integrated.

Interface 890 is used in the wired or wireless communication of signalling and/or data between network node 860, network 806, and/or WDs 810. As illustrated, interface 890 comprises port(s)/terminal(s) 894 to send and receive data, for example to and from network 806 over a wired connection. Interface 890 also includes radio front end circuitry 892 that may be coupled to, or in certain embodiments a part of, antenna 862. Radio front end circuitry 892 comprises filters 898 and amplifiers 896. Radio front end circuitry 892 may be connected to antenna 862 and processing circuitry 870. Radio front end circuitry may be configured to condition signals communicated between antenna 862 and processing circuitry 870. Radio front end circuitry 892 may receive digital data that is to be sent out to other network nodes or WDs via a wireless connection. Radio front end circuitry 892 may convert the digital data into a radio signal having the appropriate channel and bandwidth parameters using a combination of filters 898 and/or amplifiers 896. The radio signal may then be transmitted via antenna 862. Similarly, when receiving data, antenna 862 may collect radio signals which are then converted into digital data by radio front end circuitry 892. The digital data may be passed to processing circuitry 870. In other embodiments, the interface may comprise different components and/or different combinations of components.

In certain alternative embodiments, network node 860 may not include separate radio front end circuitry 892, instead, processing circuitry 870 may comprise radio front end circuitry and may be connected to antenna 862 without separate radio front end circuitry 892. Similarly, in some embodiments, all or some of RF transceiver circuitry 872 may be considered a part of interface 890. In still other embodiments, interface 890 may include one or more ports or terminals 894, radio front end circuitry 892, and RF transceiver circuitry 872, as part of a radio unit (not shown), and interface 890 may communicate with baseband processing circuitry 874, which is part of a digital unit (not shown).

Antenna 862 may include one or more antennas, or antenna arrays, configured to send and/or receive wireless signals. Antenna 862 may be coupled to radio front end circuitry 890 and may be any type of antenna capable of transmitting and receiving data and/or signals wirelessly. In some embodiments, antenna 862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 862 may be separate from network node 860 and may be connectable to network node 860 through an interface or port.

Antenna 862, interface 890, and/or processing circuitry 870 may be configured to perform any receiving operations and/or certain obtaining operations described herein as being performed by a network node. Any information, data and/or signals may be received from a wireless device, another network node and/or any other network equipment. Similarly, antenna 862, interface 890, and/or processing circuitry 870 may be configured to perform any transmitting operations described herein as being performed by a network node. Any information, data and/or signals may be transmitted to a wireless device, another network node and/or any other network equipment.

Power circuitry 887 may comprise, or be coupled to, power management circuitry and is configured to supply the components of network node 860 with power for performing the functionality described herein. Power circuitry 887 may receive power from power source 886. Power source 886 and/or power circuitry 887 may be configured to provide power to the various components of network node 860 in a form suitable for the respective components (e.g., at a voltage and current level needed for each respective component). Power source 886 may either be included in, or external to, power circuitry 887 and/or network node 860. For example, network node 860 may be connectable to an external power source (e.g., an electricity outlet) via an input circuitry or interface such as an electrical cable, whereby the external power source supplies power to power circuitry 887. As a further example, power source 886 may comprise a source of power in the form of a battery or battery pack which is connected to, or integrated in, power circuitry 887. The battery may provide backup power should the external power source fail. Other types of power sources, such as photovoltaic devices, may also be used.

Alternative embodiments of network node 860 may include additional components beyond those shown in FIG. 8 that may be responsible for providing certain aspects of the network node's functionality, including any of the functionality described herein and/or any functionality necessary to support the subject matter described herein. For example, network node 860 may include user interface equipment to allow input of information into network node 860 and to allow output of information from network node 860. This may allow a user to perform diagnostic, maintenance, repair, and other administrative functions for network node 860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 810 includes antenna 811, interface 814, processing circuitry 820, device readable medium 830, user interface equipment 832, auxiliary equipment 834, power source 836 and power circuitry 837. WD 810 may include multiple sets of one or more of the illustrated components for different wireless technologies supported by WD 810, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 810.

Antenna 811 may include one or more antennas or antenna arrays, configured to send and/or receive wireless signals, and is connected to interface 814. In certain alternative embodiments, antenna 811 may be separate from WD 810 and be connectable to WD 810 through an interface or port. Antenna 811, interface 814, and/or processing circuitry 820 may be configured to perform any receiving or transmitting operations described herein as being performed by a WD. Any information, data and/or signals may be received from a network node and/or another WD. In some embodiments, radio front end circuitry and/or antenna 811 may be considered an interface.

As illustrated, interface 814 comprises radio front end circuitry 812 and antenna 811. Radio front end circuitry 812 comprise one or more filters 818 and amplifiers 816. Radio front end circuitry 814 is connected to antenna 811 and processing circuitry 820, and is configured to condition signals communicated between antenna 811 and processing circuitry 820. Radio front end circuitry 812 may be coupled to or a part of antenna 811. In some embodiments, WD 810 may not include separate radio front end circuitry 812; rather, processing circuitry 820 may comprise radio front end circuitry and may be connected to antenna 811. Similarly, in some embodiments, some or all of RF transceiver circuitry 822 may be considered a part of interface 814. Radio front end circuitry 812 may receive digital data that is to be sent out to other network nodes or WDs via a wireless connection. Radio front end circuitry 812 may convert the digital data into a radio signal having the appropriate channel and bandwidth parameters using a combination of filters 818 and/or amplifiers 816. The radio signal may then be transmitted via antenna 811. Similarly, when receiving data, antenna 811 may collect radio signals which are then converted into digital data by radio front end circuitry 812. The digital data may be passed to processing circuitry 820. In other embodiments, the interface may comprise different components and/or different combinations of components.

Processing circuitry 820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 810 components, such as device readable medium 830, WD 810 functionality. Such functionality may include providing any of the various wireless features or benefits discussed herein. For example, processing circuitry 820 may execute instructions stored in device readable medium 830 or in memory within processing circuitry 820 to provide the functionality disclosed herein.

As illustrated, processing circuitry 820 includes one or more of RF transceiver circuitry 822, baseband processing circuitry 824, and application processing circuitry 826. In other embodiments, the processing circuitry may comprise different components and/or different combinations of components. In certain embodiments processing circuitry 820 of WD 810 may comprise a SOC. In some embodiments, RF transceiver circuitry 822, baseband processing circuitry 824, and application processing circuitry 826 may be on separate chips or sets of chips. In alternative embodiments, part or all of baseband processing circuitry 824 and application processing circuitry 826 may be combined into one chip or set of chips, and RF transceiver circuitry 822 may be on a separate chip or set of chips. In still alternative embodiments, part or all of RF transceiver circuitry 822 and baseband processing circuitry 824 may be on the same chip or set of chips, and application processing circuitry 826 may be on a separate chip or set of chips. In yet other alternative embodiments, part or all of RF transceiver circuitry 822, baseband processing circuitry 824, and application processing circuitry 826 may be combined in the same chip or set of chips. In some embodiments, RF transceiver circuitry 822 may be a part of interface 814. RF transceiver circuitry 822 may condition RF signals for processing circuitry 820.

In certain embodiments, some or all of the functionality described herein as being performed by a WD may be provided by processing circuitry 820 executing instructions stored on device readable medium 830, which in certain embodiments may be a computer-readable storage medium. In alternative embodiments, some or all of the functionality may be provided by processing circuitry 820 without executing instructions stored on a separate or discrete device readable storage medium, such as in a hard-wired manner. In any of those particular embodiments, whether executing instructions stored on a device readable storage medium or not, processing circuitry 820 can be configured to perform the described functionality. The benefits provided by such functionality are not limited to processing circuitry 820 alone or to other components of WD 810, but are enjoyed by WD 810 as a whole, and/or by end users and the wireless network generally.

Processing circuitry 820 may be configured to perform any determining, calculating, or similar operations (e.g., certain obtaining operations) described herein as being performed by a WD. These operations, as performed by processing circuitry 820, may include processing information obtained by processing circuitry 820 by, for example, converting the obtained information into other information, comparing the obtained information or converted information to information stored by WD 810, and/or performing one or more operations based on the obtained information or converted information, and as a result of said processing making a determination.

Device readable medium 830 may be operable to store a computer program, software, an application including one or more of logic, rules, code, tables, etc. and/or other instructions capable of being executed by processing circuitry 820. Device readable medium 830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 820. In some embodiments, processing circuitry 820 and device readable medium 830 may be considered to be integrated.

User interface equipment 832 may provide components that allow for a human user to interact with WD 810. Such interaction may be of many forms, such as visual, audial, tactile, etc. User interface equipment 832 may be operable to produce output to the user and to allow the user to provide input to WD 810. The type of interaction may vary depending on the type of user interface equipment 832 installed in WD 810. For example, if WD 810 is a smart phone, the interaction may be via a touch screen; if WD 810 is a smart meter, the interaction may be through a screen that provides usage (e.g., the number of gallons used) or a speaker that provides an audible alert (e.g., if smoke is detected). User interface equipment 832 may include input interfaces, devices and circuits, and output interfaces, devices and circuits. User interface equipment 832 is configured to allow input of information into WD 810, and is connected to processing circuitry 820 to allow processing circuitry 820 to process the input information. User interface equipment 832 may include, for example, a microphone, a proximity or other sensor, keys/buttons, a touch display, one or more cameras, a USB port, or other input circuitry. User interface equipment 832 is also configured to allow output of information from WD 810, and to allow processing circuitry 820 to output information from WD 810. User interface equipment 832 may include, for example, a speaker, a display, vibrating circuitry, a USB port, a headphone interface, or other output circuitry. Using one or more input and output interfaces, devices, and circuits, of user interface equipment 832, WD 810 may communicate with end users and/or the wireless network, and allow them to benefit from the functionality described herein.

Auxiliary equipment 834 is operable to provide more specific functionality which may not be generally performed by WDs. This may comprise specialized sensors for doing measurements for various purposes, interfaces for additional types of communication such as wired communications etc. The inclusion and type of components of auxiliary equipment 834 may vary depending on the embodiment and/or scenario.

Power source 836 may, in some embodiments, be in the form of a battery or battery pack. Other types of power sources, such as an external power source (e.g., an electricity outlet), photovoltaic devices or power cells, may also be used. WD 810 may further comprise power circuitry 837 for delivering power from power source 836 to the various parts of WD 810 which need power from power source 836 to carry out any functionality described or indicated herein. Power circuitry 837 may in certain embodiments comprise power management circuitry. Power circuitry 837 may additionally or alternatively be operable to receive power from an external power source; in which case WD 810 may be connectable to the external power source (such as an electricity outlet) via input circuitry or an interface such as an electrical power cable. Power circuitry 837 may also in certain embodiments be operable to deliver power from an external power source to power source 836. This may be, for example, for the charging of power source 836. Power circuitry 837 may perform any formatting, converting, or other modification to the power from power source 836 to make the power suitable for the respective components of WD 810 to which power is supplied.

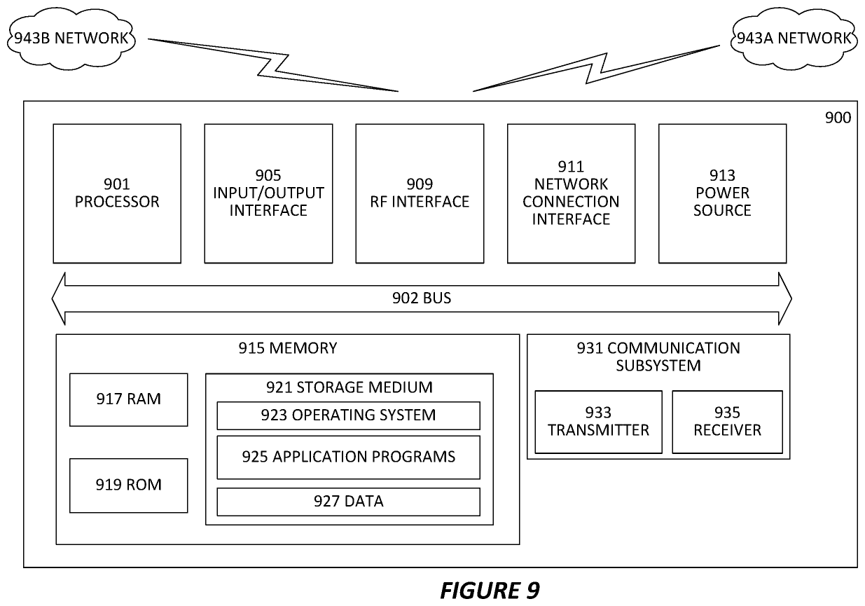

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 9200 may be any UE identified by the 3^{rd} Generation Partnership Project (3GPP), including a NB-IoT UE, a machine type communication (MTC) UE, and/or an enhanced MTC (eMTC) UE. UE 900, as illustrated in FIG. 9, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE 900 includes processing circuitry 901 that is operatively coupled to input/output interface 905, radio frequency (RF) interface 909, network connection interface 911, memory 915 including random access memory (RAM) 917, read-only memory (ROM) 919, and storage medium 921 or the like, communication subsystem 931, power source 933, and/or any other component, or any combination thereof. Storage medium 921 includes operating system 923, application program 925, and data 927. In other embodiments, storage medium 921 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 901 may be configured to process computer instructions and data. Processing circuitry 901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 901 may include two central processing units (CPUs). Data may be information in a form suitable for use by a computer.

In the depicted embodiment, input/output interface 905 may be configured to provide a communication interface to an input device, output device, or input and output device. UE 900 may be configured to use an output device via input/output interface 905. An output device may use the same type of interface port as an input device. For example, a USB port may be used to provide input to and output from UE 900. The output device may be a speaker, a sound card, a video card, a display, a monitor, a printer, an actuator, an emitter, a smartcard, another output device, or any combination thereof. UE 900 may be configured to use an input device via input/output interface 905 to allow a user to capture information into UE 900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 909 may be configured to provide a communication interface to RF components such as a transmitter, a receiver, and an antenna. Network connection interface 911 may be configured to provide a communication interface to network 943a. Network 943a may encompass wired and/or wireless networks such as a local-area network (LAN), a wide-area network (WAN), a computer network, a wireless network, a telecommunications network, another like network or any combination thereof. For example, network 943a may comprise a Wi-Fi network. Network connection interface 911 may be configured to include a receiver and a transmitter interface used to communicate with one or more other devices over a communication network according to one or more communication protocols, such as Ethernet, TCP/IP, SONET, ATM, or the like. Network connection interface 911 may implement receiver and transmitter functionality appropriate to the communication network links (e.g., optical, electrical, and the like). The transmitter and receiver functions may share circuit components, software or firmware, or alternatively may be implemented separately.

RAM 917 may be configured to interface via bus 902 to processing circuitry 901 to provide storage or caching of data or computer instructions during the execution of software programs such as the operating system, application programs, and device drivers. ROM 919 may be configured to provide computer instructions or data to processing circuitry 901. For example, ROM 919 may be configured to store invariant low-level system code or data for basic system functions such as basic input and output (I/O), startup, or reception of keystrokes from a keyboard that are stored in a non-volatile memory. Storage medium 921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 921 may be configured to include operating system 923, application program 925 such as a web browser application, a widget or gadget engine or another application, and data file 927. Storage medium 921 may store, for use by UE 900, any of a variety of various operating systems or combinations of operating systems.

Storage medium 921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 921 may allow UE 900 to access computer-executable instructions, application programs or the like, stored on transitory or non-transitory memory media, to off-load data, or to upload data. An article of manufacture, such as one utilizing a communication system may be tangibly embodied in storage medium 921, which may comprise a device readable medium.

In FIG. 9, processing circuitry 901 may be configured to communicate with network 943b using communication subsystem 931. Network 943a and network 943b may be the same network or networks or different network or networks. Communication subsystem 931 may be configured to include one or more transceivers used to communicate with network 943b. For example, communication subsystem 931 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 933 and/or receiver 935 to implement transmitter or receiver functionality, respectively, appropriate to the RAN links (e.g., frequency allocations and the like). Further, transmitter 933 and receiver 935 of each transceiver may share circuit components, software or firmware, or alternatively may be implemented separately.

In the illustrated embodiment, the communication functions of communication subsystem 931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 931 may include cellular communication, Wi-Fi communication, Bluetooth communication, and GPS communication. Network 943b may encompass wired and/or wireless networks such as a local-area network (LAN), a wide-area network (WAN), a computer network, a wireless network, a telecommunications network, another like network or any combination thereof. For example, network 943b may be a cellular network, a Wi-Fi network, and/or a near-field network. Power source 913 may be configured to provide alternating current (AC) or direct current (DC) power to components of UE 900.

The features, benefits and/or functions described herein may be implemented in one of the components of UE 900 or partitioned across multiple components of UE 900. Further, the features, benefits, and/or functions described herein may be implemented in any combination of hardware, software or firmware. In one example, communication subsystem 931 may be configured to include any of the components described herein. Further, processing circuitry 901 may be configured to communicate with any of such components over bus 902. In another example, any of such components may be represented by program instructions stored in memory that when executed by processing circuitry 901 perform the corresponding functions described herein. In another example, the functionality of any of such components may be partitioned between processing circuitry 901 and communication subsystem 931. In another example, the non-computationally intensive functions of any of such components may be implemented in software or firmware and the computationally intensive functions may be implemented in hardware.

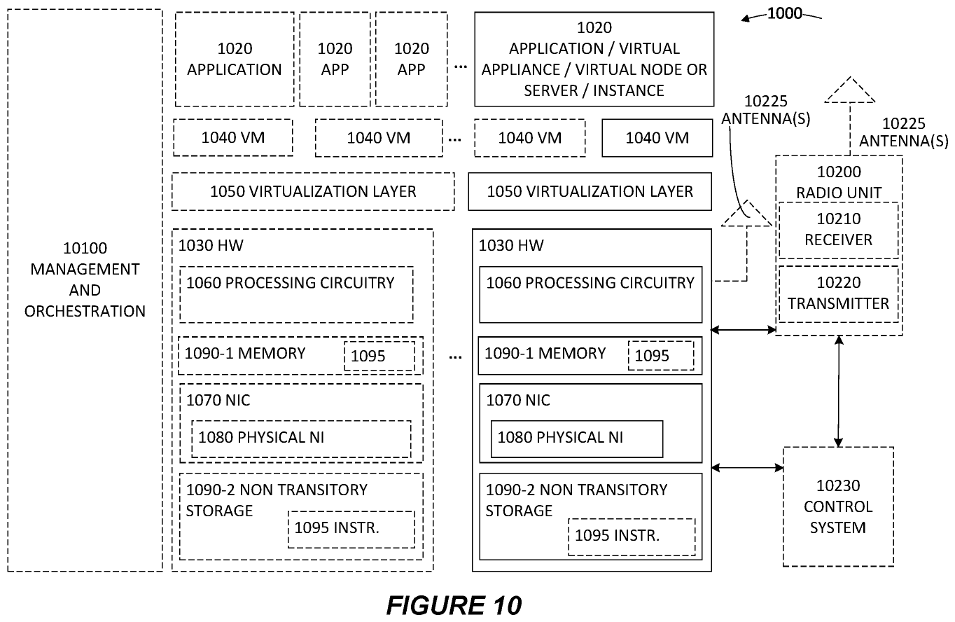

FIG. 10 is a schematic block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1000 hosted by one or more of hardware nodes 1030. Further, in embodiments in which the virtual node is not a radio access node or does not require radio connectivity (e.g., a core network node), then the network node may be entirely virtualized.

The functions may be implemented by one or more applications 1020 (which may alternatively be called software instances, virtual appliances, network functions, virtual nodes, virtual network functions, etc.) operative to implement some of the features, functions, and/or benefits of some of the embodiments disclosed herein. Applications 1020 are run in virtualization environment 1000 which provides hardware 1030 comprising processing circuitry 1060 and memory 1090. Memory 1090 contains instructions 1095 executable by processing circuitry 1060 whereby application 1020 is operative to provide one or more of the features, benefits, and/or functions disclosed herein.

Virtualization environment 1000, comprises general-purpose or special-purpose network hardware devices 1030 comprising a set of one or more processors or processing circuitry 1060, which may be commercial off-the-shelf (COTS) processors, dedicated Application Specific Integrated Circuits (ASICs), or any other type of processing circuitry including digital or analog hardware components or special purpose processors. Each hardware device may comprise memory 1090-1 which may be non-persistent memory for temporarily storing instructions 1095 or software executed by processing circuitry 1060. Each hardware device may comprise one or more network interface controllers (NICs) 1070, also known as network interface cards, which include physical network interface 1080. Each hardware device may also include non-transitory, persistent, machine-readable storage media 1090-2 having stored therein software 1095 and/or instructions executable by processing circuitry 1060. Software 1095 may include any type of software including software for instantiating one or more virtualization layers 1050 (also referred to as hypervisors), software to execute virtual machines 1040 as well as software allowing it to execute functions, features and/or benefits described in relation with some embodiments described herein.

Virtual machines 1040, comprise virtual processing, virtual memory, virtual networking or interface and virtual storage, and may be run by a corresponding virtualization layer 1050 or hypervisor. Different embodiments of the instance of virtual appliance 1020 may be implemented on one or more of virtual machines 1040, and the implementations may be made in different ways.

During operation, processing circuitry 1060 executes software 1095 to instantiate the hypervisor or virtualization layer 1050, which may sometimes be referred to as a virtual machine monitor (VMM). Virtualization layer 1050 may present a virtual operating platform that appears like networking hardware to virtual machine 1040.

As shown in FIG. 10, hardware 1030 may be a standalone network node with generic or specific components. Hardware 1030 may comprise antenna 10225 and may implement some functions via virtualization. Alternatively, hardware 1030 may be part of a larger cluster of hardware (e.g. such as in a data center or customer premise equipment (CPE)) where many hardware nodes work together and are managed via management and orchestration (MANO) 10100, which, among others, oversees lifecycle management of applications 1020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1040 may be a software implementation of a physical machine that runs programs as if they were executing on a physical, non-virtualized machine. Each of virtual machines 1040, and that part of hardware 1030 that executes that virtual machine, be it hardware dedicated to that virtual machine and/or hardware shared by that virtual machine with others of the virtual machines 1040, forms a separate virtual network elements (VNE).

Still in the context of NFV, Virtual Network Function (VNF) is responsible for handling specific network functions that run in one or more virtual machines 1040 on top of hardware networking infrastructure 1030 and corresponds to application 1020 in FIG. 10.

In some embodiments, one or more radio units 10200 that each include one or more transmitters 10220 and one or more receivers 10210 may be coupled to one or more antennas 10225. Radio units 10200 may communicate directly with hardware nodes 1030 via one or more appropriate network interfaces and may be used in combination with the virtual components to provide a virtual node with radio capabilities, such as a radio access node or a base station.

In some embodiments, some signalling can be effected with the use of control system 10230 which may alternatively be used for communication between the hardware nodes 1030 and radio units 10200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1. A method performed by network equipment (20) configured for use in a wireless communication network (10), the method comprising:
determining (100) an inter-network interference condition (50C) measured by a set of sensors (30) deployed in a coverage area of the wireless communication network (10), wherein the inter-network interference condition (50C) characterizes interference to the wireless communication network (10) from one or more other wireless communication networks (50); and
adapting (110), based on the determined inter-network interference condition (50C), time division duplexing, TDD, configuration (14) of one or more radio network nodes (12) in the wireless communication network (10).

2. The method of claim 1, further comprising obtaining (120) a model that models, for each of multiple candidate TDD configurations of the one or more radio network nodes (12), performance achievable with the candidate TDD configuration under different inter-network interference conditions, and wherein said adapting comprises:
selecting (110A), from the candidate TDD configurations, a candidate TDD configuration that, according to the model, achieves a performance objective under an inter-network interference condition corresponding to the determined inter-network interference condition (50C); and
configuring (110B) the one or more radio network nodes (12) with the selected candidate TDD configuration.

3. The method of claim 2, wherein obtaining the model comprises obtaining a labeled dataset that comprises one or more measurement records for each of the candidate TDD configurations, wherein each measurement record comprises a measurement of performance achieved with the candidate TDD configuration and a measurement by the set of sensors (30) of an inter-network interference condition under which the performance was measured.

4. The method of claim 3, wherein each measurement record also comprises a measurement of a channel condition at one or more wireless devices under which the performance was measured.

5. The method of claim 3, wherein said selecting comprises:
selecting, from among one or more measurement records that include a measurement of an inter-network interference condition that is similar to the determined inter-network interference condition (50C) according to similarity criteria, a measurement record that includes a measurement of performance meeting a performance objective; and
selecting the candidate TDD configuration for which the selected measurement record was obtained.

6. The method of claim 2, wherein said selecting comprises selecting, from the candidate TDD configurations, a candidate TDD configuration that, according to the model, achieves a performance objective while meeting one or more performance constraints, under an inter-network interference condition corresponding to the determined inter-network interference condition (50C).

7. The method of claim 6, wherein the performance objective comprises a maximum sum-throughput of the wireless communication network (10), and wherein the one or more performance constraints include a bounded latency and minimum throughput for each wireless communication device in the wireless communication network (10).

8. The method of claim 2, wherein said adapting comprises adapting, based on the determined inter-network interference condition (50C), TDD configuration (14) of multiple radio network nodes in the wireless communication network (10), and wherein each candidate TDD configuration is a candidate combination of multiple TDD patterns with which to respectively configure the multiple radio network nodes.

9. The method of claim 1, further comprising configuring at least one of any one or more of:
a bandwidth or frequency range over which the set of sensors (30) detects the inter-network interference condition (50C);
a center frequency at which the set of sensors (30) detects the inter-network interference condition (50C);
a quantity in terms of which the set of sensors (30) detects the inter-network interference condition (50C); and
an interval at which the set of sensors (30) detects the inter-network interference condition (50C).

10. The method of claim 1, wherein said adapting is further based on weights respectively assigned to sensors (30) in the set.

11. The method of claim 1, wherein said adapting comprises adapting, based on the determined inter-network interference condition (50C), a combination of TDD patterns with which respective radio network nodes in the wireless communication network (10) are configured.

12. The method of claim 1, wherein said adapting comprises adapting TDD configuration (14) of the one or more radio network nodes (12) further based on traffic to be communicated in the wireless communication network (10).

13. The method of claim 1, wherein the inter-network interference condition (50C) characterizes cross-link interference to the wireless communication network (10) from one or more other wireless communication networks (50).

14. The method of claim 1, wherein the inter-network interference condition (50C) characterizes at least out-of-band interference to the wireless communication network (10) from one or more other wireless communication networks (50).

15. The method of claim 1, wherein at least some of the sensors (30) in the set are deployed at fixed locations within the coverage area of the wireless communication network (10) and/or are dedicated to detecting inter-network interference conditions.

16. The method of claim 1, wherein the wireless communication network (10) is an industrial internet-of-things, IoT, network.

17. Network equipment (20) configured for use in a wireless communication network (10), the network equipment (20) configured to:
determine an inter-network interference condition (50C) measured by a set of sensors (30) deployed in a coverage area of the wireless communication network (10), wherein the inter-network interference condition (50C) characterizes interference to the wireless communication network (10) from one or more other wireless communication networks (50); and
adapt, based on the determined inter-network interference condition (50C), time division duplexing, TDD, configuration (14) of one or more radio network nodes (12) in the wireless communication network (10).

18. Network equipment (20) configured for use in a wireless communication network (10), the network equipment (20) configured to:
determine an inter-network interference condition (50C) measured by a set of sensors (30) deployed in a coverage area of the wireless communication network (10), wherein the inter-network interference condition (50C) characterizes interference to the wireless communication network (10) from one or more other wireless communication networks (50);
adapt, based on the determined inter-network interference condition (50C), time division duplexing, TDD, configuration (14) of one or more radio network nodes (12) in the wireless communication network (10); and
perform the method of claim 2.

19. A computer program comprising instructions which, when executed on at least one processor of network equipment (20), cause the network equipment (20) to perform the method of claim 1.

20. A carrier containing the computer program of claim 19, wherein the carrier comprises one of an electronic signal, optical signal, radio signal, or computer readable storage medium.

21.-22. (canceled)
